(19) United States
(12) Patent Application Publication
(10) Pub. No.: US 2025/0310479 A1
(43) Pub. Date: Oct. 2, 2025

(54) Multi-Participant Sharing In A Video Conference

(71) Applicant: Zoom Communications, Inc., San Jose, CA (US)

(72) Inventors: Miao Jin, Hangzhou (CN); Chunhan Li, Hangzhou (CN); Gang Ren, Hangzhou (CN); Pan Zhang, Hangzhou (CN); Yamin Zhou, Hangzhou (CN)

(21) Appl. No.: 18/623,575

(22) Filed: Apr. 1, 2024

(51) Int. Cl. H04N 7/15; G06F 3/14

(52) U.S. Cl. CPC H04N 7/152; G06F 3/1454

(57) ABSTRACT

A selection of a subset of content streams transmitted by presenting devices is received at a viewing device connected to a conference. Each of the content streams is transmitted from a respective presenting device connected to the conference and each presenting device is associated with a respective conference participant. The subset of the content streams is received by the viewing device. At least one of the subset of the content streams is displayed by the viewing device.

### FIELD

This disclosure generally relates to video conferencing, and, more specifically, to enabling multiple conference participants to simultaneously share displays in a video conference.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 illustrates a block diagram of a system for facilitating multi-user content sharing in a video conference.

FIG. 6 is a block diagram of an example of functionality of presenter conferencing software that may be included in a presenting device.

FIG. 7 is an example of a user interface that a presenting participant can use to select displays for sharing in a video conference.

FIG. 8 is a block diagram of an example of functionality of viewer conferencing software.

FIGS. 9A-9C are examples of user interfaces for displaying shared displays at a viewing device.

FIG. 10 is a block diagram of an example of functionality of conferencing software.

FIG. 11 is a swim lane diagram of an example sequence of operations performed between a first presenting device, a second presenting device, a server device, and a viewing device.

FIG. 12 is a flowchart of an example of a technique for viewing multiple displays shared in a video conference.

FIG. 13 is a flowchart of an example of a technique for sharing, at a presenting device, multiple displays in a video conference.

FIG. 14 is a flowchart of an example of a technique for facilitating the sharing and viewing of displays shared by multiple presenting participants in a video conference.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

A conferencing application may enable a conference participant who is presenting content during a video conference (that participant referred to herein as a “presenting participant”) to share to share, during a conference, content displayed on displays of respective devices used to join the conference with the other participants of the conference (those participants referred to herein as “viewing participants”). The content sharing (e.g., display, desktop, document, or application sharing) capability allows for the dynamic presentation of content, making it possible for conference participants to showcase visual aids, documents, software applications, and more. The disclosure herein may use terms similar to “shared display” or “sharing a display.” Such terms should be understood to mean that content displayed on that display is shared to a conference.

Conventional conferencing software approaches restrict the sharing of content (such as a software display (e.g., showing the operating system and application visual output at a computing device), a document, or an application) to a single presenting participant at a time. When one presenting participant is sharing content and another participant wishes to share theirs, the first presenter may stop their share, followed by the second presenter initiating a new share session. This sequential sharing process often leads to interruptions and breaks in the meeting's continuity, as participants must wait for the transition between presenters. Moreover, in some instances, the second presenter may simply assume (e.g., take over) the presenter role from a current presenter by initiating their share, which automatically ends the first presenter's session, further disrupting the flow of information sharing. When the presenting participant changes, the viewing participants are no longer able to see (such as to further reflect on or analyze) the content that was previously shared by another presenting participant. Changing the presenter changes replaces the content being viewed by other participants therewith resulting in frustration, interruptions, and potential confusion.

A conferencing application according to implementations of this disclosure solves problems such as these by enabling several participants to simultaneously share content in a conference. One such participant may be a current (e.g., primary) presenter and the other presenters may be designated as (e.g., identified as or considered to be) secondary presenters. The conferencing application enables easy and seamless switching between primary and secondary presenters. While the content of the primary presenter may be prominently featured in the conference, the content shared by any of the presenters (i.e., the primary and the secondary presenters) are independently available to each of the other participants, such as in a selectable or navigable sidebar or overlay.

Viewing participants can easily select which of the shared displays to view during the conference. A viewing participant may view one of the shared content one at a time or may arrange them for simultaneous viewing. Multiple participant sharing in a meeting enables seamless sharing of multiple contents without constant interruptions, ensuring that content that viewing participants wish to view is easily accessible without causing disruptions.

In some implementations, a selection of a subset of content streams transmitted by presenting devices is received at a viewing device connected to a conference. Each of the content streams is transmitted from a respective presenting device connected to the conference and each presenting device is associated with a respective conference participant. The subset of the content streams is received by (i.e., at and by) the viewing device. At least one of the subset of the content streams is displayed by the viewing device.

In other implementations, a conferencing server receives content streams from presenting devices connected to a conference. Each content stream is received from a respective one of the presenting devices. The conferencing server transmits the content streams to a viewing device connected to the conference. The conferencing server receives a request to designate one of the presenting devices as a primary presenting device. The conferencing server then transmits an indication of the primary presenting device to the viewing device.

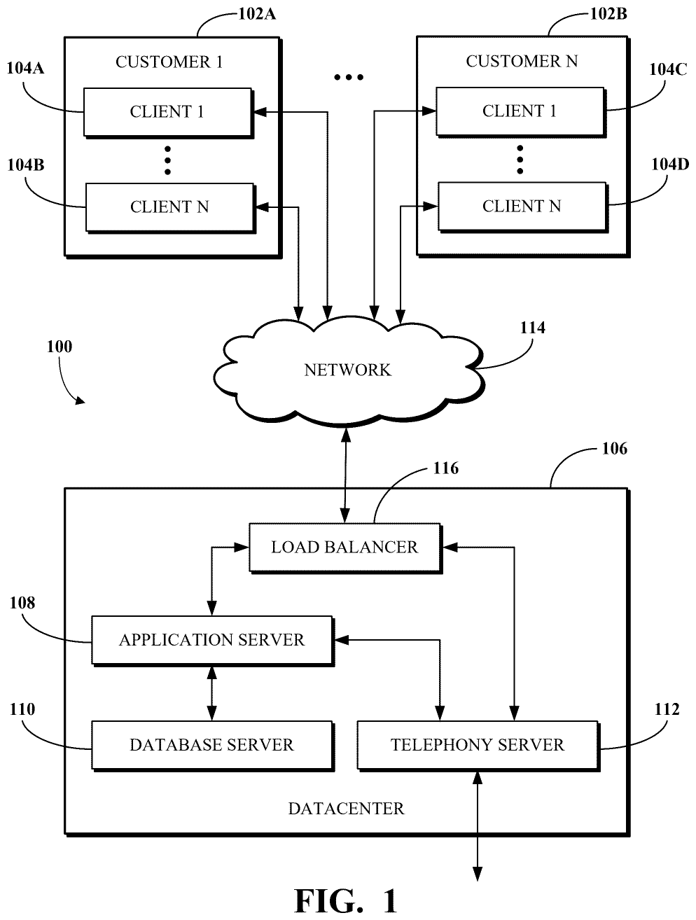

To describe some implementations in greater detail, reference is first made to examples of hardware and software structures used to implement a system for enabling multiple conference participants to simultaneously share displays in a video conference. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

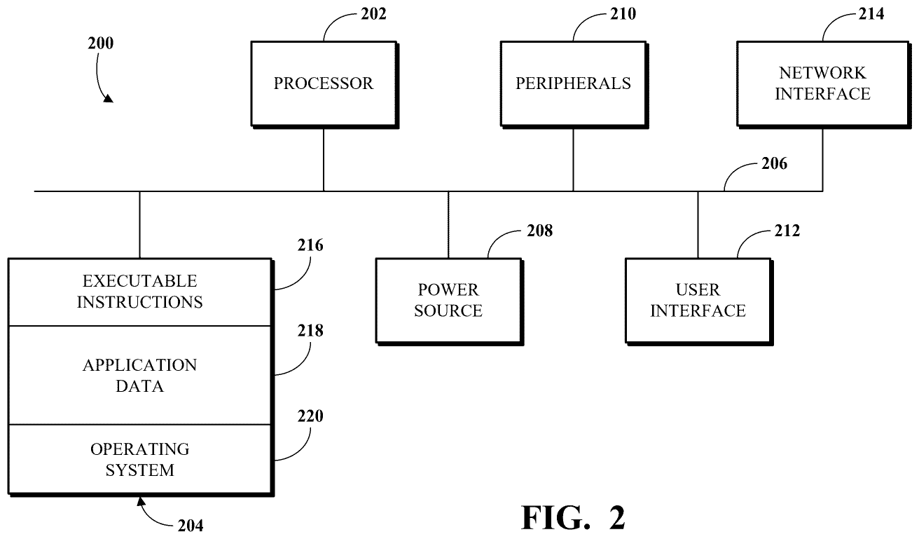

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 702.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

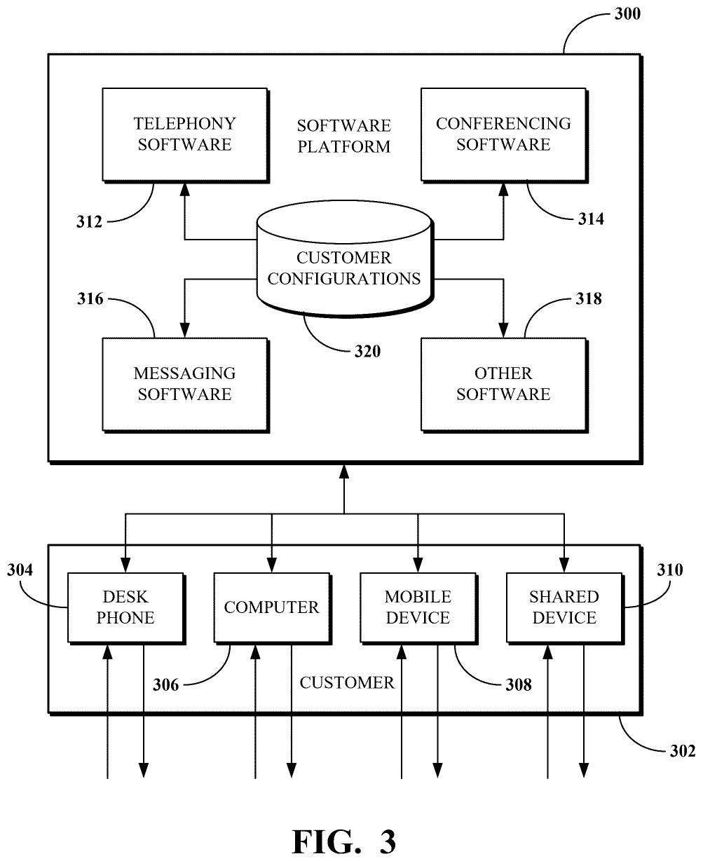

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for enabling multiple conference participant to simultaneously share displays in a video conference. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

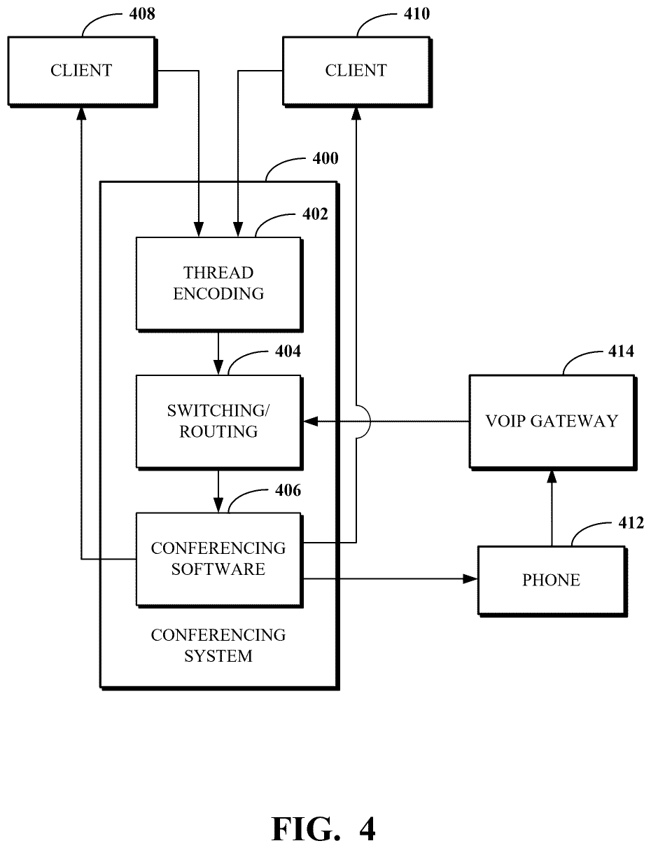

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or a like coupling aspect. After the video streams are encoded, the switching/routing tool 404 directs the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

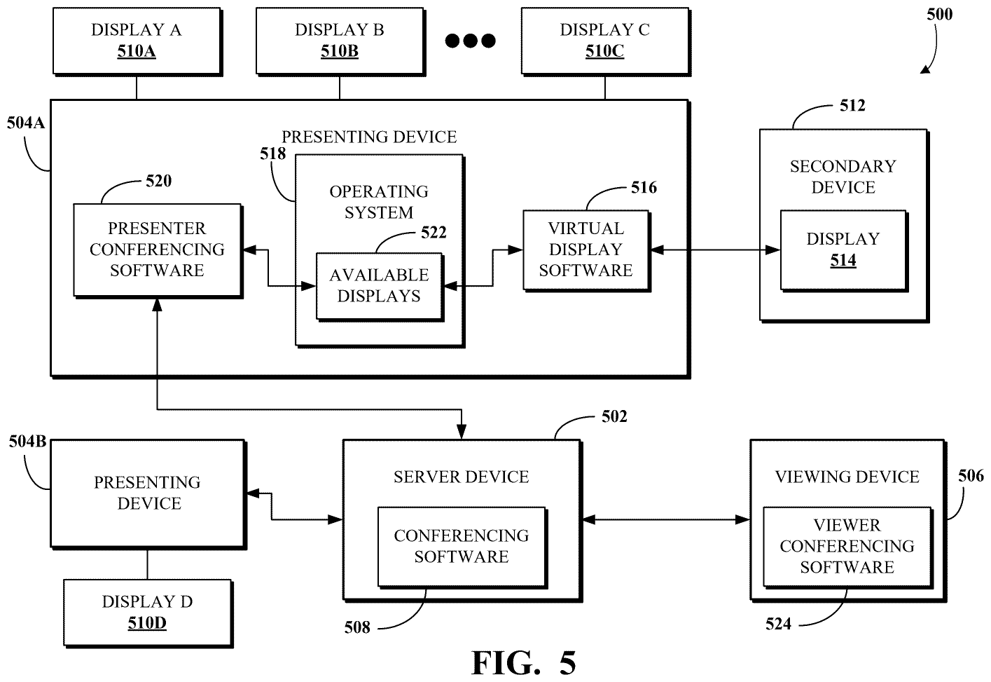

FIG. 5 illustrates a block diagram of a system 500 for facilitating multi-user content sharing in a video conference. The system 500 includes a server device 502 and three participant devices that are connected to the video conference. The participant devices include two presenting devices (e.g., a presenting device 504A and a presenting device 504B) and a viewing device 506. The presenting devices 504A and 504B and the viewing device 506 establish respective connections to the video conference hosted or enabled by conferencing software 508 operating on the server device 502. The conferencing software 508 can be the conferencing software 406 shown in FIG. 4.

Although only three participant devices are shown in FIG. 5, the system 500 is capable of accommodating a significantly larger number of devices (or, equivalently, conference participants), potentially engaging in multiple concurrent video conferences hosted by server device 502. It is also noted that the roles of devices within this system are interchangeable. That is, a viewing device can itself also be, concurrently or at a different time, a presenting device, and vice versa.

The presenting device 504A is associated with a presenting participant who shares, in the video conference (e.g., with the other participants), content of at least one display of the presenting device 504A. The presenting device 504A may include or be connected to displays 510A through 510C (labeled, for ease of reference, as “DISPLAY A,” “DISPLAY B,” and “DISPLAY C,” respectively), which may be as described with respect to the output interfaces of FIG. 2. In an example, the presenting device 504A may also be connected to a secondary device 512 that includes a display 514, which the presenting participant may also share in the conference. For ease of reference, the displays 510A through 510C and the display 514 are each referred to as a “display.” The presenting device 504B can be similar (e.g., be similarly configured) to the presenting device 504A. That is, the presenting device 504B may also include a presenter conferencing software (such as the presenter conferencing software 520 (introduced below) of the presenting device 504A), and may also include a virtual display software (such as virtual display software 516 of the presenting device 504A). However, for brevity, the presenting device 504B is only shown as including or being connected to one display, namely a display 510D that is labeled “DISPLAY D.”

Each of the presenting devices 504A-504B and the viewing device 506 may, for example, be one of the clients 408 or 410 shown in FIG. 4. Each of the presenting devices 504A-504B can be a personal computing device used by the presenting participant. Each of the presenting devices 504A-50B and the viewing device 506 may be a laptop computer, a tablet computer, a desktop computer, or a smartphone. The secondary device 512 can be a personal or shared computing device that is communicatively (e.g., wiredly or wirelessly) connected to the presenting device 504A during at least a portion of the video conference. The secondary device 512 may be a laptop computer, a tablet computer, a desktop computer, a smartphone, a conference room audio/visual system device, a television, a digital signage device, a digital whiteboard device, or a video-enabled smart speaker device.

The virtual display software 516 enables the presenting device 504A to use the display 514 of the secondary device 512 to share content from the presenting device 504A in the video conference. The virtual display software 516 may include functionality for instantiating a virtual display associated with the display 514 of the secondary device 512 based on a connection established between the presenting device 504A and the secondary device 512. The virtual display software 516 configures the display 514 as a virtual display of the presenting device 504A by causing the installation of a virtual device driver for the display 514 at the presenting device 504A. The virtual device driver is software that configures an operating system 518 of the presenting device 504A to recognize the display 514 as an additional (e.g., extended) display usable for obtaining screen content displayed at the display 514, and thus to recognize the display 514 as if it were a native display of the presenting device 504A. Although the virtual display software 516 is shown and described as being separate from a presenter conferencing software 520, in some implementations, the virtual display software 516 may be included in the presenter conferencing software 520. The virtual display driver, once installed, updates a configuration of available displays 522 at the presenting device 504A to add a virtual display bound to the display 514.

The virtual display software 516 establishes a connection between a first device (e.g., the presenting device 504A) and a second device (e.g., the secondary device 512). The connection between the first device and the second device may be by way of one or more of ultrasonic pairing, sharing key, Bluetooth pairing, ultra-wide band communication, Wi-Fi, ZigBee, operating system-specific casting protocols (e.g., Airplay® or Google Cast®), or another local network or protocol. The virtual display software 516 may establish the connection between the first device and the second device based on a selection at the first device of the second device from a list of available devices to which to connect. For example, a client application (e.g., the presenter conferencing software 520) running at the first device may prompt a user of the first device with a list of devices with which a connection may be established, and the user of the first device may select the second device from the list of devices. Alternatively, the virtual display software 516 may establish the connection between the first device and the second device based on a detection of the second device by the virtual display software 516 or another software aspect at the first device. For example, the virtual display software 516 may establish a connection between the first device and the second device over an ultrasonic pairing based on an ultrasonic signal transmitted from the second device being detected at the first device.

In some cases, the virtual display software 516 may establish the connection between the first device and the second device based on a prior connection between the first device and the second device or otherwise based on an authentication by the first device to connect to or otherwise access the second device. For example, the first device or a conferencing system data store accessible to the first device (e.g., via the virtual display software 516) may store information associated with past connections to other devices. In some such cases, the virtual display software 516 running at the first device can detect the second device, such as when the first device is moved within a threshold range of the second device (e.g., a detectable range, such as a range at which an ultrasonic, Bluetooth, or other signal from the second device can be detected at the first device), the virtual display software 516 may prompt the user of the first device to indicate whether or not to connect the first device to the second device. In some cases, configurations defined for use with the virtual display software 516 (e.g., by or for an account administrator) may control a length of a detectable range for connecting to a second device. In some cases, such configurations may also or instead control an amount of time that a prior connection between the first device and the second device may remain available for determining a new connection between those devices.

The operating system 518 may assign a distinct descriptor for each (physical or virtual) display of the available displays 522, such as a display number, a hardware identifier, or similar identifiers. The operating system 518 may also maintain (e.g., manage) respective frame buffers for the available displays 522. The operating system 518 allocates a portion of a graphics memory (which includes the frame buffers) of the presenting device 504A to store the pixel data displayed at a corresponding display.

The presenting device 504A connects to the video conference using the presenter conferencing software 520. The presenter conferencing software 520 may, for example, be a desktop software application, mobile application, or web application associated with one or more services of a software platform, for example, the software platform 300 shown in FIG. 3. In such a case, the server device 502 may be a computing device used to implement one or more software services of the software platform, for example, services corresponding to one or more of the software 312 through 318 shown in FIG. 3. For example, the presenter conferencing software 520 may be software that allows a user of the presenting device 504A to access or otherwise use one or more of the software 312 through 318. As such, the presenter conferencing software 520 can be or can be included in a client, such the client 408 or the client 410 of FIG. 4.

A presenter conferencing software (such as the presenter conferencing software 520 520) can be used by the presenting participant to select one or more of the available displays from the available displays (such as the available displays 522) for sharing to the video conference. For each of the selected displays, the presenter conferencing software (such as the presenter conferencing software 520) transmits a corresponding content stream of the content displayed at that selected display to the conferencing software 508, which in turn transmits the received content streams to the viewing device 506. The viewing device 506 includes a viewer conferencing software 524. The viewer conferencing software 524 enables a viewing participant associated with the viewing device 506 to, for example, select which of the received content streams to display by the viewing device 506. The presenter conferencing software 520 and the viewer conferencing software 524 can be the same conferencing application. That is, the presenter conferencing software 520 may implement features similar to those described herein with the viewer conferencing software 524, and vice versa.

The presenter conferencing software 520 may transmit separate content streams corresponding to the shared displays. Alternatively, the presenter conferencing software 520 may transmit the multiple content streams in a single content stream. For example, the presenter conferencing software 520 may segment each content feed corresponding to a display into packets and interleave these packets within the single content stream, each packet uniquely identifiable as belonging to a specific content stream. Along with the video packets, metadata can be transmitted that enables the server device 502 and/or the viewing device 506 to identify and select individual streams. The metadata can include information such as content stream identifiers, timestamps, and potentially thumbnail previews. As further described herein, the server device 502 may, for example, selectively re-transmit different subsets of the received content streams to different viewing devices.

The conferencing software 508 enables multiple participants to simultaneously share displays during the video conference, thereby facilitating a collaborative and interactive environment. Equivalently, or said another way, the conferencing software 508 enables multiple devices connected to the video conference to simultaneously have displays associated therewith shared to the video conference. Participants engaged in sharing their displays are referred to as presenting participants, and their associated devices are termed presenting devices. Within this multi-user setup, no more than one participant can assume the role of a primary presenting participant at any given time. The primary presenter is distinguished by their ability to designate a specific display as the focus display, which is highlighted or prioritized in the video conference to draw the attention of the viewers to content deemed by the primary presenter most important at the moment. Among the presenting participants, no more than one participant can be designated as the primary presenting participant, while all others presenting participants are considered (e.g., referred to as) secondary presenting participants, and their devices are referred to as secondary presenting devices.

A primary presenting participant has control over the content they wish to share and can typically manage aspects of the conference related to their presentation, such as starting or stopping the share, switching between different pieces of content, or annotating shared materials for emphasis. The primary presenting participant role can be transferred between participants during the video conference.

As such, the conferencing software 508 may receive a request from one a device connected to the video conference to designate that device as a primary presenting device. Upon receiving such a request, the conferencing software 508 may perform actions that facilitate the designation and ensure the smooth execution of the video conference.

The conferencing software 508 may dynamically adjust the video, content, and/or audio streams to prioritize the content shared by the primary presenting participant, ensuring that their display becomes the main focus for all other conference participants. To illustrate, in a selective forwarding implementation, where the conferencing software 508 may selectively (such as based on bandwidth or importance of a stream) forward a subset of received streams to conference participants, the conferencing software 508 determines that the displays shared by the primary presenting participant are of high importance and are, therefore, to be transmitted to the conference participants.

The conferencing software 508 may transmit, to the other conference participants, content streams received from the primary presenting device at a higher quality and/or resolution compared to those from secondary presenting participants. As such, the shared content of the primary presenting participant can be delivered with enhanced clarity and detail, making it easier for the other participants to, for example, view complex diagrams, read text, and follow along with the presentation. The conferencing software 508 may automatically optimize the bandwidth allocation and encoding settings for the content stream of the primary presenting participant. s

The conferencing software 508 may grant enhanced control features to the primary presenting participant, such as the ability to mute or unmute other participants, control the flow of the presentation, and manage the sharing permissions of secondary presenters. As such, the primary presenter can effectively guide the conference without unintended interruptions. The conferencing software 508 may enable the primary presenter to utilize advanced content sharing features, including screen annotations, real-time editing of shared documents, and the use of virtual pointers or highlighting tools. The conferencing software 508 may integrate with external applications or services to allow the primary presenting participant to incorporate diverse content types into their presentation, such as live polls, quizzes, or interactive Q&A sessions.

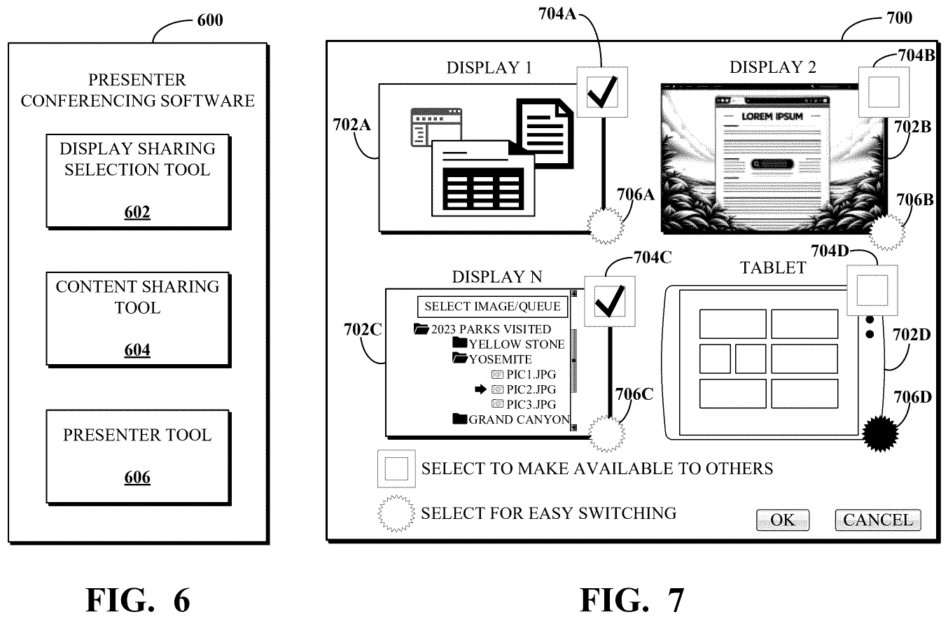

FIG. 6 is a block diagram of an example of functionality of presenter conferencing software 600 that may be included in a presenting device, such as the presenting device 504A or the presenting device 504B of FIG. 5. As such, the presenter conferencing software 600 can be the presenter conferencing software 520 shown in FIG. 5. The presenter conferencing software 600 includes tools, such as programs, subprograms, functions, routines, subroutines, operations, and/or the like for sharing multiple displays to a conference. As shown, the presenter conferencing software 600 includes a display sharing selection tool 602, a content sharing tool 604, and a presenter tool 606.

The display sharing selection tool 602 enables the presenting participant associated with a presenting device (e.g., one or more of the presenting devices 504A or 504B of FIG. 5) to select one or more displays of the presenting device to share in a conference and to switch which is the focus display during the conference. The operations of the display sharing selection tool 602 are further described with respect to FIG. 7.

The term “focus display” refers to the display that the primary presenting participant has actively selected to emphasize during the video conference. This selection signals to the viewing participants that the content of this display is currently of primary importance or relevance. However, it is important to note that this designation does not restrict viewing participants' access to other shared displays. Each of the other participants may choose to view any of the shared displays at any time, even if it is not the current focus display. The concept of a “focus display” is primarily applicable when the presenting participant is as the primary presenter in the conference. That is, if the participant is a secondary presenter, then the display designated as a focus display is not afforded any special treatment and is thus considered to be similar to any other shared display.

FIG. 7 is an example of a user interface 700 that a presenting participant can use to select displays for sharing in a video conference. The user interface 700 can be presented by a presenter conferencing software, such as the presenter conferencing software 600 of FIG. 6, at a display of a presenting device, such as one of the presenting devices 504A or 504B of FIG. 5.

The user interface 700 includes a respective preview window for each display of the presenting device. For example, the presenter conferencing software may obtain (e.g., retrieve) the list of available devices, such as described with respect to the available displays 522 of FIG. 5, from an operating system of the presenting device, such as the operating system 518 of FIG. 5. FIG. 7 illustrates preview windows 702A, 702B, 702C, and 702D corresponding, respectively, to displays 510A, 510B, 510C, and 514 of FIG. 5.

In the user interface 700, each preview window is equipped with an associated selector. The presenting participant can select (e.g., check or choose) at least some of the selectors to indicate that the presenter conferencing software is to make the content of the selected displays available to viewing devices of the conference. A display that is selected by the presenting participant is referred to herein as “shared display.” Sharing displays implies that, while the presenting participant may designate a specific display as the focal point at a given moment during the video conference, viewing participants retain the freedom to access and view the currently displayed contents output at any of the shared displays of the presenter's device. That is, while the presenting participant may have currently selected one display (i.e., a “focus display”) as the shared focal point, it is entirely possible for one or more viewing participants to concurrently view the content of shared displays. As shown in FIG. 7, the presenting participant has selected to share the displays associated with the selectors 704A and 704C (e.g., the displays labeled “DISPLAY A” and “DISPLAY N”).

In certain situations, the presenting participant may indicate to the presenter conferencing software that the presenting participant intends to share one or more displays in the video conference but that such displays are not to be marked as (e.g., designated or considered) shared displays. That is, the presenting participant may identify the one or more displays for easy and convenient switching to during the conference. Such displays are referred to as “switchable displays.” In this context, viewing participants are unable to view the contents of a switchable display unless the presenting participant specifically designates the switchable display as the focus display. Within the user interface 700, each available display may be equipped with an associated selector (e.g., selectors 706A-706D) that enables the presenting participant to indicate which of the available displays are switchable displays. As shown in FIG. 7, the presenting participant has indicated that the display 514 is a switchable display by selecting the selector 706D associated with the preview window 702D. It is noted that a shared display cannot be designated as a switchable display.

Referring again to FIG. 6, the content sharing tool 604 facilitates a screen share of content during the video conference from the presenting device to viewing devices (e.g., the viewing device 506 of FIG. 5). In particular, the content sharing tool 604 facilitates the screen share of content by transmitting respective content streams of the shared displays. Each content stream corresponding to a shared display includes the content output at that shared display. The video streams are to a conferencing software (e.g., the conferencing software 508 of FIG. 5), which in turn transmits the content streams to other the viewing devices.

The content sharing tool 604 also transmits a content stream associated with a switchable display when that switchable display is the focus display. Additionally, the content sharing tool 604 may transmit an audio stream from the presenting device to the viewing devices. Regardless of the number of transmitted content streams, the content sharing tool 604 transmits no more than one audio stream. The content sharing tool 604 may transmit, such as via the conferencing software, metadata to the viewing devices indicating which of the transmitted content streams are associated with shared displays, labels (e.g., descriptors) associated therewith, and which of the transmitted content stream is associated with the focus display.

The content sharing tool 604 may capture and transmit the focus display at a higher frame rate compared to other shared displays. This differentiation in frame rates can be predicated on the observation that non-focus displays often become static or experience minimal changes in content when the presenting user is not actively engaged with them. The non-focus displays (i.e., the content streams associated therewith) can be transmitted at a significantly lower frame rate without compromising the overall user experience at viewing devices. To illustrate, and without limitations, whereas a focus display may be captured at a rate that is between 5 and 30 frames per second (fps), a focus display may be captured at a rate of 1 to 2 fps.

The content sharing tool 604 may implement a monitoring mechanism that continuously observes shared displays for changes, and only transmit the screen content when a modification is detected. The content sharing tool 604 may periodically capture an image of a shared display that is not a focus display, followed by subsequent captures at defined intervals, and then comparing these images to identify any differences, indicating a change in the displayed content. The content sharing tool 604 may perform a pixel-by-pixel comparison between successive image captures to detect changes. However, the content sharing tool 604 may be configured to disregard certain predictable changes, such as those in a clock display or pop-up notifications, typically located at the bottom right corner, to prevent unnecessary transmissions due to these expected changes.

The content sharing tool 604 may apply different compression settings to the content streams. The content sharing tool 604 may adapt the compression settings based on whether a content stream corresponds to a focus display. The focus display might receive less compression to preserve quality, given its importance, while content streams associated with other non-focus displays might be more heavily compressed to save bandwidth. The content sharing tool 604 may selectively transmit content streams at varying resolutions. For example, the content sharing tool 604 nay transmit the content stream associated with a focus screen at a higher resolution compared to the content streams associated with other shared displays.

The content sharing tool 604 may receive instructions (e.g., requests) from the conferencing software to modify compression settings, resolution settings, and/or capture frame rate associated with different displays. For example, when another device becomes the primary presenting device, the conferencing software may transmit instructions to at least some (e.g., all) of the secondary presenting devices to increase the compression rate, to lower the resolution, and/or to decrease the frame rate associated with content streams of their respective shared displays.

The presenter tool 606 enables a participant to request presenter role. In response to the request, the presenter tool 606 transmits a request to the conferencing software to designate the participant as the primary presenter.

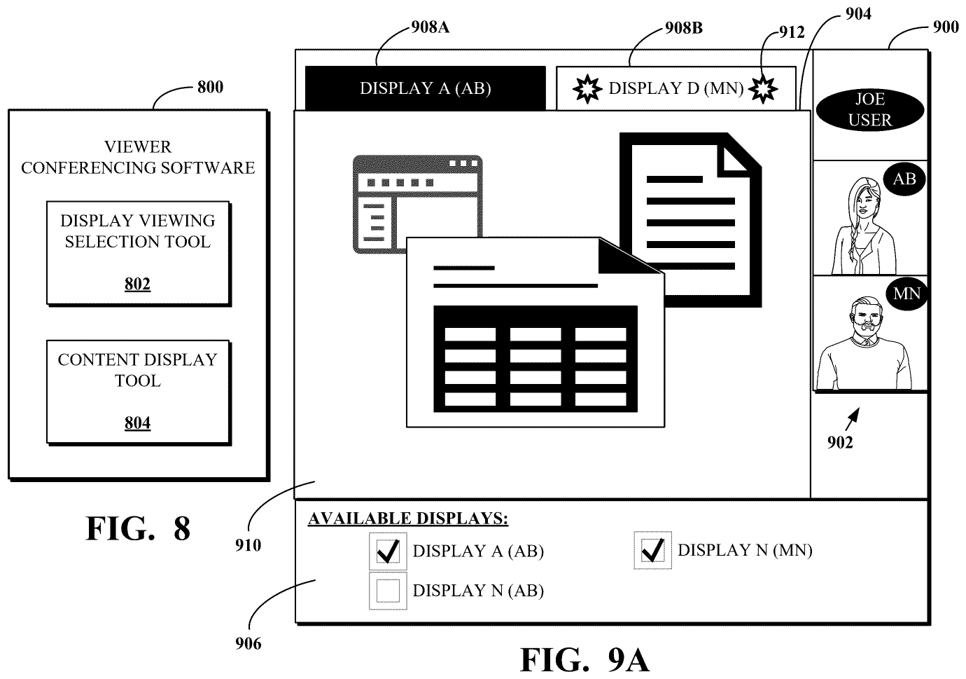

FIG. 8 is a block diagram of an example of functionality of viewer conferencing software 800, which may, for example, be the viewer conferencing software 524 shown in FIG. 5. The viewer conferencing software 800 includes tools, such as programs, subprograms, functions, routines, subroutines, operations, and/or the like for viewing one or more shared displays at a viewing device. As shown, the viewer conferencing software 800 includes a display viewing selection tool 802 and a content display tool 804.

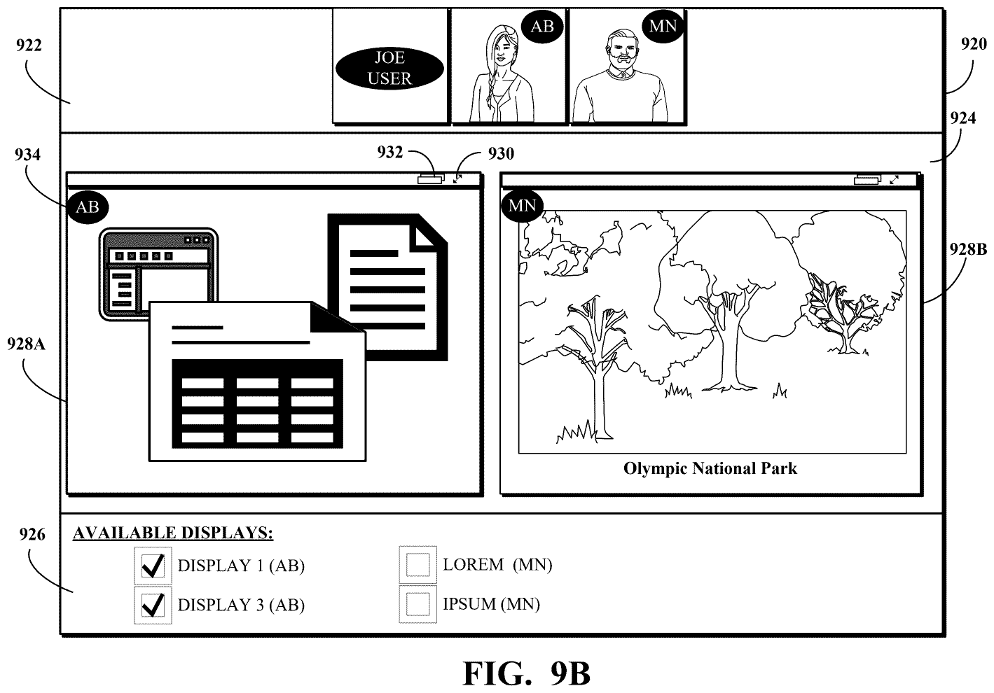

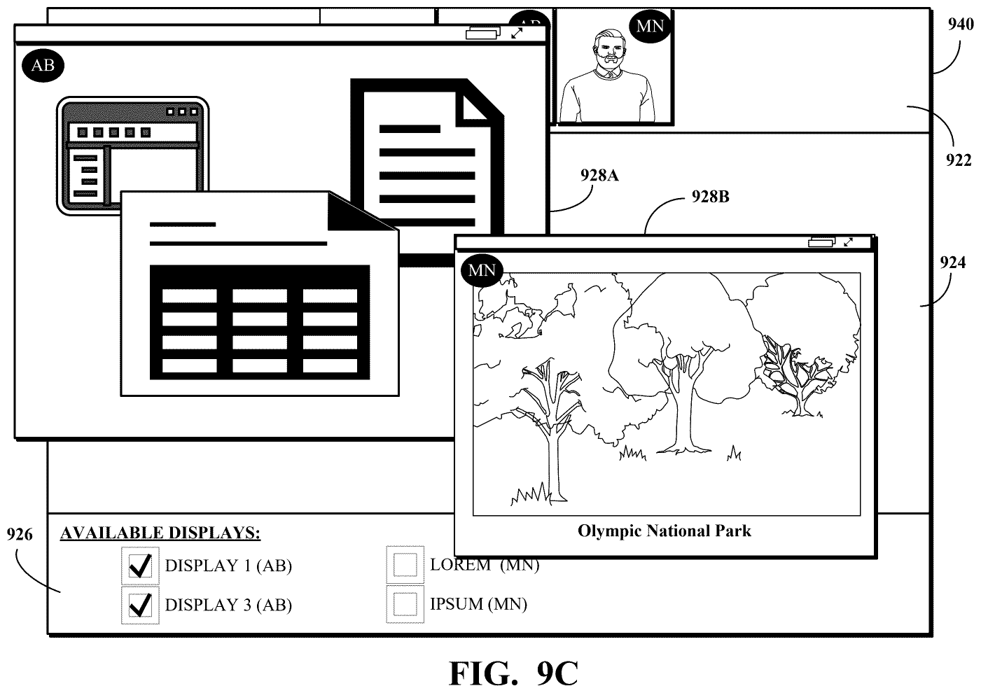

The display viewing selection tool 802 enables a viewing participant associated with a viewing device (e.g., the viewing device 506 of FIG. 5) to select, arrange, and/or view one or more shared displays by the viewing device. The one or more shared displays may be displays shared by one or more presenting participants. The operations of the display viewing selection tool 802 are illustrated with respect to FIGS. 9A-9C.

The content display tool 804 receives content streams associated with the video conference and determines which of the content streams to output by the viewing device. The content display tool 804 outputs content streams based on a user interface configuration set via the display viewing selection tool 802. The content display tool 804 also receives metadata associated with the content streams. As mentioned herein, the metadata includes labels (e.g., descriptors) associated with the received content streams and an indication of the focus display. The content display tool 804 may also receive, such as from the conferencing software, an indication of which of the presenting devices is the primary presenting device, if any. The display viewing selection tool 802 can use the metadata in the user interfaces of FIGS. 9A-9C. In an example, the viewing participant can configure the viewer conferencing software 800 to display the content streams according to a selected configuration (e.g., arrangement), such as those described with respect to FIGS. 9A-9C. For example, the content display tool 804 may enable the viewing participant to select an arrangement from amongst possible arrangements, such as those described with respect to FIGS. 9A-9C.

FIGS. 9A-9C are examples of user interfaces for displaying shared displays at a viewing device. The user interfaces of FIGS. 9A-9C can be generated by a viewing selection tool, such as the display viewing selection tool 802 of FIG. 8. While not specifically shown, the viewing participant may configure the viewing selection tool to output the shared displays according to one of the users interfaces of FIG. 9A-9C or some other arrangement.

FIG. 9A is an example of a tabbed user interface 900 for displaying shared displays. The tabbed user interface 900 may include a gallery 902 that includes, for at least some of the conference participants of a video conference, corresponding digital representations. A digital representation of a conference participant may be a label (e.g., a name), an image, a content stream obtained via a camera of the device of the conference participant, or some other digital representation.

A tabbed user interface component 904 may include a tab for each of the shared displays selected by the viewing participant via a stream selector area 906. The stream selector area 906 includes a list of shared displays. To illustrate, as shown in FIG. 9A, the stream selector area 906 includes two shared displays (e.g., labeled “DISPLAY A” and “DISPLAY B”) shared by the presenting participant whose initials are “AB” and one shared display (e.g., labeled “DISPLAY N”) shared by the presenting participant whose initials are “MN.” The viewing participant can use the stream selector area 906 at any time during the video conference to configure which of the shared displays are to be associated with tabs of the tabbed user interface component 904.

The user interface 900 indicates that the viewing participant has selected “DISPLAY A” and “DISPLAY D,” corresponding, respectively, to the display 510A and the display 510D of FIG. 5 indicated as shared displays as described with respect to FIG. 7. As such, the tabbed user interface 900 includes a tab 908A and a tab 908B corresponding, respectively, to the display 510A and the display 510D of FIG. 5. In response to the viewing participant selecting a tab (e.g., one of the tabs 908A or 908B), a content display tool, such as the content display tool 804 of FIG. 8, causes the content stream corresponding to the shared display associated with that tab to be output (i.e., to be played) in an output area 910. The content streams associated with non-selected (not currently active) tabs are not output.

In another example, the user interface 900 may not include a stream selector area 906 and the tabbed user interface component 904 may simply include a tab for each shared display of the video conference.

A received content stream may be compressed (i.e., encoded) using a video codec (such as H.265, AV1, or H.266). Content streams received by the viewing device but are not output (i.e., played) may not be decompressed (i.e., decoded). In an example, the conferencing software (e.g., the conferencing software 508 of FIG. 5) may only transmit to the viewing device only those content streams corresponding to the selected shared displays. As such, a viewer conferencing software transmits a list of identifiers of the selected shared displays, which causes the conferencing software to transmit, to the viewing device, only those content streams corresponding to the selected shared displays. The conferencing software may also transmit the focus display of the presenting participant, if not included in the list of selected displays.

In another example, the conferencing software transmits to the viewing device only those currently playing content streams at the viewing device. As such, the viewer conferencing software may transmit a list of identifiers of the currently playing content streams and the conferencing software transmits only those content streams to the viewing device. Accordingly, while the conferencing software may receive from the presenting devices content streams associated with all shared displays at those presenting devices, the conferencing software may transmit different subsets of these content streams to different viewing devices.

If the focus display selected by a presenting participant at a primary presenting device is a different shared display from the display selected for viewing by the viewing participant, then the display viewing selection tool may highlight the difference. This disclosure is not limited to or by any particular highlighting. Any highlighting that draws the attention of the viewing participant can be used. The highlighting may be indicated via colors, flashing, adornments, or any other highlighting technique. To illustrate, in the user interface 900, the tab 908B corresponding to the focus display at the presenting device is highlighted by adding adornments 912 (e.g., two stars) to the tab 908B indicating that that is the focus display. Additionally, or alternatively, the highlighting may be indicated in the gallery 902 and/or the stream selector area 906. For example, if no tab corresponds to a focus display, then primary participant may be highlighted in the gallery 902 and/or the identifier of the focus display may be highlighted in the stream selector area 906.

If the primary presenting participant shares a switchable display, then the display viewing selection tool 802 may add an additional tab to the tabbed user interface component 904. In an example, the additional tab may be labeled “Currently Shared.” When the presenting participant stops sharing a switchable display, then the additional tab is removed.

FIG. 9B is an example of a grid arrangement 920 for displaying shared displays. The grid arrangement 920 includes a gallery 922, which can be similar to the gallery 902 of FIG. 9A, a content area 924, and a stream selector area 926, which can be similar to the stream selector area 906 of FIG. 9A. The viewer conferencing software includes a video player window, such as video player windows 928A and 928B, for each of the shared displays selected by the viewing participant via the stream selector area 926. In an example, the grid arrangement 920 may not include the stream selector area 926, as described above. In the grid arrangement 920, the content area 924 can be divided into a number of rows and columns such that video player windows are displayed in each cell. The number of rows and columns can depend on the number of selected shared displays.

Each video player window can be associated with respective resizing controls, such as a control 930, that the viewing participant can use to resize the video player window. Resizing one video player window may cause other cells of the grid to also be resized. Each video player window can be associated with respective docking/undocking controls, such as a control 932, that the viewing participant can use to undock the video player window from the content area 924 and to redock a video player window into the content area 924. By undocking a video player window, the video player window becomes a floating window that can be placed anywhere on the display of the viewing device and is no longer confined to the content area 924, as shown in FIG. 9C.

Each video player window (e.g., the video player windows 928A and 928B) may be annotated (e.g., highlighted) to indicate the presenting participant that it is associated with. To illustrate, an annotation 934 indicates that the video player windows 928A is playing a content stream received from a presenting device associated with the participant whose initials are “AB.”

FIG. 9C is an example of a user interface 940 illustrating undocking of video player windows. As mentioned above, when a video player window is undocked, it is no longer confined to the content area 924 of FIG. 9B. An undocked video player window can be placed anywhere on the desktop (e.g., screen) of the viewing device. The ability to undock video player windows enables the viewing participant to flexibly stack and overlay the video player windows. FIG. 9C shows that the video player windows 928A and 928B have been undocked and that the video player window 928A has been resized.

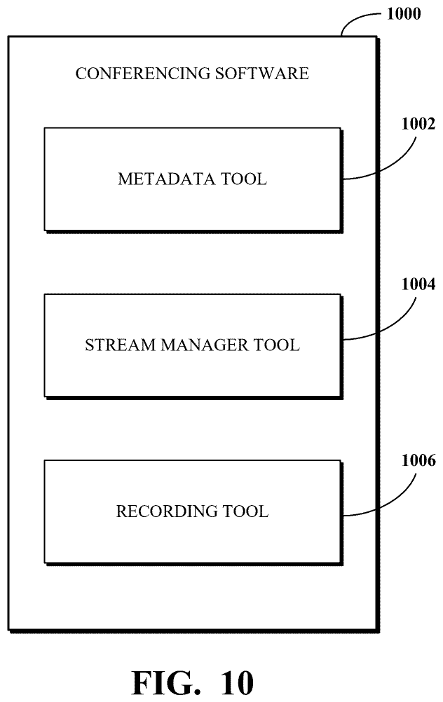

FIG. 10 is a block diagram of an example of functionality of conferencing software 1000, which may, for example, be the conferencing software 508 of FIG. 5 shown in FIG. 5. The conferencing software 1000 includes tools, such as programs, subprograms, functions, routines, subroutines, operations, and/or the like for enabling multiple conference participants to simultaneously share displays in a video conference. As shown, the conferencing software 1000 includes a metadata tool 1002, a stream manager tool 1004, and a recording tool 1006.

The metadata tool 1002 receives from each presenting device metadata associated with shared displays at that presenting device. The metadata may include respective identifiers for the shared displays. The metadata may also include an identifier of a focus display from the primary presenting device. The metadata tool transmits, to each viewing device, metadata describing the shared displays at the presenting devices. That is, the metadata aggregates all the metadata received from the presenting devices for transmission to the viewing devices thereby enabling viewing participants to know which streams are available for selection, such as described with respect to the stream selector area 906 of FIG. 9. The metadata transmitted to the viewing devices includes an indication of the primary presenting device and the focus display.

A device may transmit the metadata to the conferencing software 1000 when a change in which displays are shared occurs. The metadata tool 1002 transmits metadata to the viewing devices when a change in the shared displays is identified based on the received metadata.

The stream manager tool 1004 manages (e.g., orchestrates) the flow of content streams from presenting devices to viewing devices. The stream manager tool 1004 receives content streams from presenting devices and determines which streams to forward to which viewing devices based on content streams selected for receipt at those viewing devices. In an example, if no specific selection of a subset of the content streams is received from a viewing device, the stream manager tool 1004 may be configured to transmit all of the received content streams to that viewing device. In another example, if no specific selection of a subset of the content streams is received from a viewing device, the stream manager tool 1004 may be configured to only transmit the content stream associated with a focus display.

The stream manager tool 1004 can ensure efficient bandwidth use and viewing participant engagement by not forwarding content streams to devices where their associated displays are not selected. Furthermore, when a primary presenting device is set, the stream manager tool 1004 may send instructions (e.g., requests or commands) to the secondary presenting devices to increase compression for content streams received from those secondary presenting devices as compared to compression settings used for content streams received from a primary presenting device. In an example, all content streams, regardless of the presenting device they initiate from, may be encoded using compression settings that provide higher compression than the compression settings used to encode the content stream associated with the focus display. Additionally, for a display not chosen at a viewing device, the stream manager tool 1004 may re-encode the associated content stream at a higher compression rate prior to transmitting that content stream to the viewing device.

The recording tool 1006 can be configured, such as by a conference participant associated with a participant device, to record the video conference, with associated settings to dictate the handling of content streams in the recording. For instance, one setting may enable the recording tool 1006 to capture only focus streams; another setting may configure the recording tool 1006 to include all content streams in the recording, irrespective of their transmission to the participant device; yet another setting may direct the recording tool 1006 to record only those content streams actively selected by the participant (e.g., the content streams actually transmitted to the participant device). Yet another setting may direct the recording tool 1006 to record at least some of the content streams. At least one the at least some the content streams may be transmitted to the participant; and at least another may not be transmitted to the participant.

The recording tool 1006 may utilize a template to determine the arrangement of the content streams in the recording, such as a grid layout. One specific template may highlight the focus display at the center with a larger size compared to other streams surrounding it, ensuring a prioritized display of primary content amidst secondary streams. Various other templates can also be applied, offering a range of organizational schemes for recorded content.

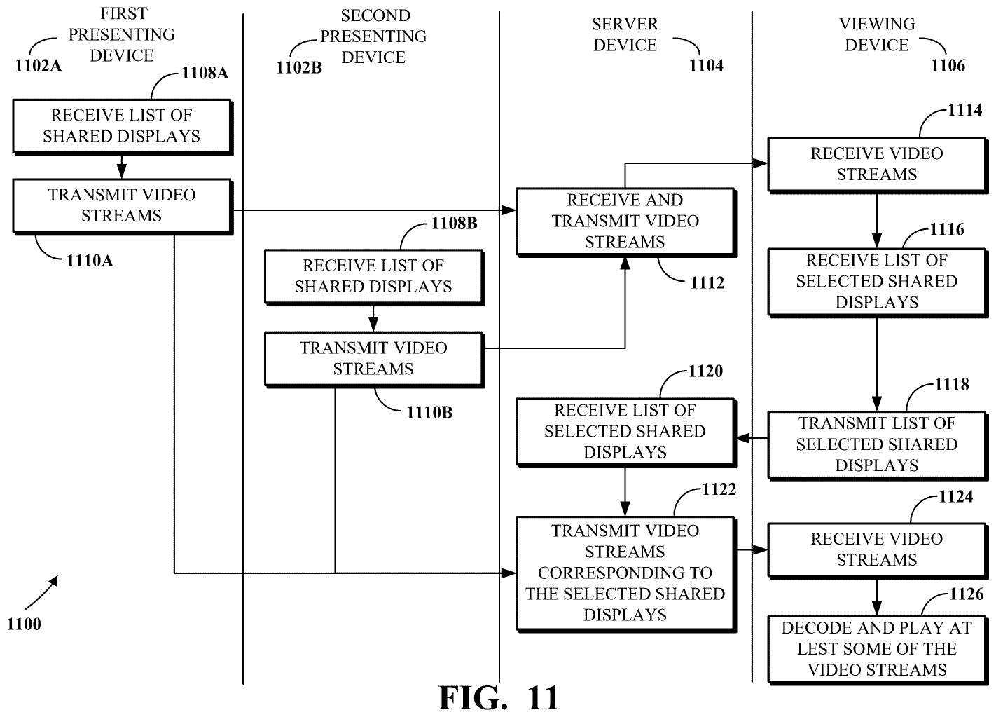

FIG. 11 is a swim lane diagram 1100 of an example sequence of operations performed between a first presenting device 1102A, a second presenting device 1102B, a server device 1104, and a viewing device 1106, which may, for example, respectively be the presenting device 504A, the presenting device 504B, the server device 502, and the viewing device 506 shown in FIG. 5. The swim lane diagram 1100 illustrates, while not specifically shown, that the presenting devices 1102A-1102B and the viewing device 1106 are connected to a video conference that is hosted (e.g., managed) by the server device 1104.

At 1108A, the first presenting device 1102A receives a list of shared displays, such as from a first conference participant (e.g., a first presenting participant) associated with the first presenting device 1102A. The list of shared displays can be received as described with respect to FIG. 7. At 1110A, the first presenting device 1102A transmits the content streams associated with the shared displays to the server device 1104. Similarly, at 1108B, the second presenting device 1102B receives a list of shared displays, such as from a second conference participant (e.g., a second presenting participant) associated with the second presenting device 1102B. At 1110B, the second presenting device 1102B transmits the content streams associated with the shared displays to the server device 1104.

At 1112, the server device 1104 receives the content streams and transmits them (e.g., the content streams received from each of the first presenting device 1102A and the second presenting device 1102B) to the viewing device 1106. As long as a presenting device is configured (such as by the presenting participant associated therewith) to share at least one display of the presenting device, the presenting device may continuously transmit content streams of the shared display(s).

At 1114, the viewing device 1106 receives the content streams. As described above, the viewing device 1106 may receive data identifying the content streams, which can also include an identification (e.g., an indication) of a focus display at a presenting device. The identifying data can also include data associating presenting participants with the content streams received therefrom (e.g., content streams received from presenting devices associated with the presenting participants). As such, initially (e.g., before the viewing participant selects a subset of the shared displays for viewing), the viewing device 1106 may play the content stream associated with the focus display.

At 1116, the viewing device receives a list of selected shared displays. The list of selected shared displays can be received from a viewing participant. The list of selected shared displays can be received as described with respect to the stream selector area 906 of FIG. 9A or the stream selector area 926 of FIG. 9B and FIG. 9C. As such, the list of selected shared displays can include zero or more displays associated with the first presenting device 1102A and zero or more displays associated with the second presenting device 1102B.

At 1118, the viewing device 1106 transmits the list of shared displays to the server device 1104, which receives the list of shared displays, at 1120. In response to receiving the list of shared displays, the server device 1104 stops transmitting content streams associated with non-selected shared displays to the viewing device 1106. As such, at 1122, the server device 1104 transmits content streams corresponding to the selected shared displays to the viewing device 1106. At 1124, the viewing device 1106 receives the content streams. At 1126, the viewing device 1106 decodes and plays (e.g., outputs) at least some of the received content streams. Only those content streams currently viewable at the viewing device are decoded and played.

To further describe some implementations in greater detail, reference is next made to examples of techniques which may be performed by or using a system for enabling multiple conference participant to simultaneously share displays in a video conference.

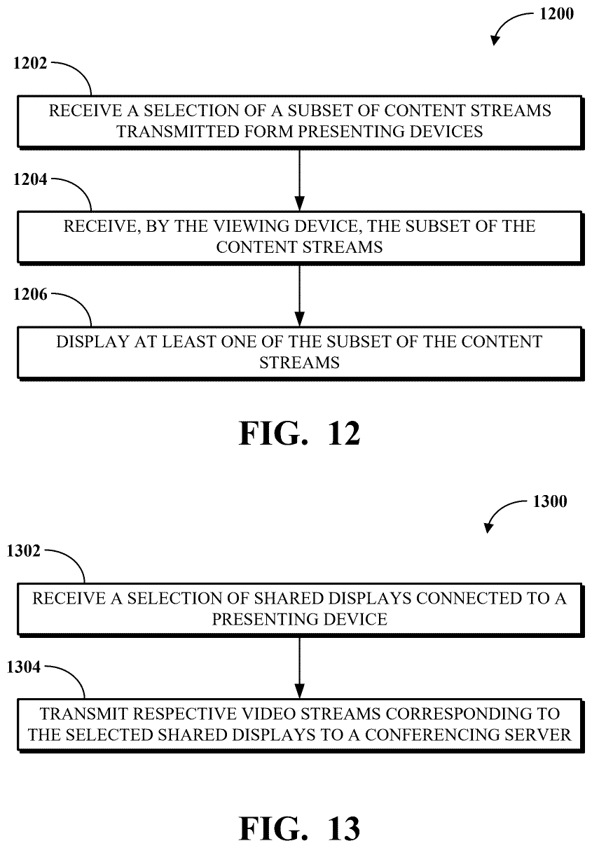

FIG. 12 is a flowchart of an example of a technique 1200 for viewing multiple displays shared in a video conference. The technique 1200 can be executed using computing devices, such as the systems, hardware, and software described with respect to FIGS. 1-10. The technique 1200 can be performed, for example, by executing a machine-readable program or other computer-executable instructions, such as routines, instructions, programs, or other code. The steps, or operations, of the technique 1200, or another technique, method, process, or algorithm described in connection with the implementations disclosed herein can be implemented directly in hardware, firmware, software executed by hardware, circuitry, or a combination thereof. The technique 1200 can be implemented by a viewing device, such as the viewing device 506 of FIG. 5 or the viewing device 1106 of FIG. 11.

At 1202, a selection of a subset of content streams transmitted from one or more presenting devices. As described herein, more than one content stream of the content streams may be transmitted by the same presenting device of the one or more presenting devices. For example, some of the content streams may be transmitted by the first presenting device 1102A of FIG. 11 and some others of the content streams may be transmitted by the second presenting device 1102B of FIG. 11. The one or more presenting devices and the viewing device are connected to a video conference and the content streams correspond to content streams of content displayed at corresponding shared displays of the one or more presenting devices. The subset of the content streams are associated with different devices (e.g., physical monitors or secondary devices) connected to the presenting devices. The selection of the subset of content streams may be received as described with respect to FIGS. 9A-9C.

At 1204, the subset of the content streams are received by the viewing device. Receiving the subset of the content streams includes receiving all of the content streams. As described above, the receiving device may still receive, from a conferencing software, such as the conferencing software 1000 of FIG. 10, all of the content streams but may not decode content streams not included in the subset of the content streams. The content streams that are not decoded can be discarded. In another example, and as also described herein, the conferencing software only transmits the subset of the content streams to the viewing device. The subset of the content streams can be received as separate content streams or as a single content stream.

At 1206, at least one of the subset of the content streams is displayed by the viewing device. In an example, each of the at least one of the subset of the content streams can be associated with a corresponding tab of a tabbed user interface, such as described with respect to FIG. 9A. As such, when the tab is selected, the associated content stream is played. In another example, the at least one of the subset of the content streams can be displayed in a grid user interface, such as described with respect to FIG. 9B.

If a tabbed user interface is used (e.g., selected by the viewing participant), then only one of the content streams can be played (e.g., viewable) at a time. The content stream can be displayed (e.g., played) in response to a selection of the content stream. Selecting the content stream can be indicated by selecting a tab, such as the one of the tabs 908A or 908B of FIG. 9A, associated with the content stream. In another example, such as described with respect to FIGS. 9A and 9B, all of the at least one of the subset of the content streams can be simultaneously played. That is, if the at least one of the subset of the content streams include at least two content streams, then the at least two content streams can be simultaneously displayed (e.g., played) by the viewing device.

The technique 1200 may include receiving an indication to display another content stream of the subset of the content streams that is different from the at least one of the subset of the content streams. For example, the viewing participant may select a different tab in the tabbed interface. In response to the indication, a currently playing content stream (e.g., the at least one of the subset of the content streams) is stopped and the another content stream is displayed (e.g., played). Stopping displaying a content stream can include continuing to receive the video but stopping decoding of the content stream.

The technique 1200 may transmit an indication to the conferencing software to stop transmitting the content stream to the viewing device. The technique 1200 may adaptively transmit the indication to the conferencing software based on detecting limited bandwidth at the viewing device therewith optimizing for efficient use of available network resources. Limited bandwidth can be detected in any number of known techniques. For example, limited bandwidth may be detected by continuously monitoring the network throughput at the viewing device and comparing it against predefined thresholds to identify when the available bandwidth falls below an optimal level. Additionally, packet loss rates and latency measurements can be analyzed in real-time to provide further insights into the network's capacity constraints, thereby identifying when bandwidth is becoming limited.

The technique 1200 may include receiving, from the presenting device, an indication of a display shared at the presenting device. That is, the viewing device may receive an indication, via the conferencing software, of a focus display that is different from a currently displayed content stream. In response to the indication, one of the content streams associated with the display shared at the presenting device is highlighted, such as described with respect to the adornments 912 of FIG. 9.

The viewing device may receive an indication that one of the content streams is (e.g., has been designated as) a primary content stream. For example, the conferencing software may transmit the indication to the viewing device in response to one of the conference participants becoming a primary presenter and the content stream is associated with a focus display at presenting device of the primary presenter. The conference participant may have requested and was granted the presenter role. In response to receiving the indication, the one of the content streams (e.g., the primary content stream) is highlighted at the viewing device.

One audio stream may be received from the presenting device. The audio stream can be output via an audio output device (e.g., a speaker or a headset) connected to the viewing device.

FIG. 13 is a flowchart of an example of a technique 1300 for sharing, at a presenting device, multiple displays in a video conference. The technique 1300 can be executed using computing devices, such as the systems, hardware, and software described with respect to FIGS. 1-10. The technique 1300 can be performed, for example, by executing a machine-readable program or other computer-executable instructions, such as routines, instructions, programs, or other code. The steps, or operations, of the technique 1300, or another technique, method, process, or algorithm described in connection with the implementations disclosed herein can be implemented directly in hardware, firmware, software executed by hardware, circuitry, or a combination thereof. The technique 1300 can be implemented by a presenting device, such as one of the presenting devices 504A or 504B of FIG. 5, the first presenting device 1102A of FIG. 11, or the second presenting device 1102B of FIG. 11.

At 1302, a selection of shared displays connected to the presenting device is received. In an example, the selection of the shared displays can be received as described with respect to FIG. 7. At least one of the shared displays may be a virtual display of a secondary device connected to the presenting device, such as described with respect to the display 514 of FIG. 5. At 1304, respective content streams corresponding to the selected shared displays are transmitted to a conferencing server, such as the conferencing server device 502 of FIG. 5. The respective content streams can be transmitted in a single multiplexed content stream.

The technique 1300 can include transmitting a single audio stream, captured at the presenting device, in association with the respective content streams. A content stream of the content streams corresponding to a focus display may be transmitted at a higher resolution than other content streams associated with shared displays that are not the focus display. The content stream associated with (e.g., corresponding to) the focus display can be captured at a first frame rate that is higher than a second frame rate used for capturing content streams of the respective content streams not associated with the focus display. Said another way, the content of the focus display can be captured at the first frame rate and the content of non-focus shared displays are captured at the second frame rate. The technique 1300 can apply higher compression settings to content streams not associated with the focus display than compression settings applied to the content stream associated with the focus display.

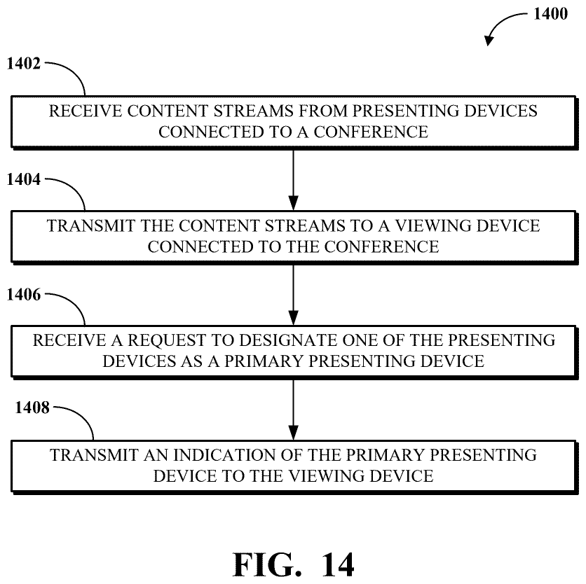

FIG. 14 is a flowchart of an example of a technique 1400 for facilitating the sharing and viewing of displays shared by multiple presenting participants in a video conference. The technique 1400 can be executed using computing devices, such as the systems, hardware, and software described with respect to FIGS. 1-10. The technique 1400 can be performed, for example, by executing a machine-readable program or other computer-executable instructions, such as routines, instructions, programs, or other code. The steps, or operations, of the technique 1400, or another technique, method, process, or algorithm described in connection with the implementations disclosed herein can be implemented directly in hardware, firmware, software executed by hardware, circuitry, or a combination thereof. The technique 1400 can be implemented by a conferencing server, such as the server device 502 of FIG. 5 or the server device 1104 of FIG. 11. The technique 1400 can be implemented by a conferencing software, such as the conferencing software 508 of FIG. 5 or the conferencing software 1000 of FIG. 10.

At 1402, content streams are received from presenting devices connected to a conference that is hosted by the conferencing software. Each content stream is received from a respective one of the presenting devices. As such, more than one of the content streams may be received from one presenting device. At 1404, the content streams are transmitted to a viewing device that is also connected to the conference. The technique 1400 may transmit, to the viewing device, metadata indicating a respective source presenting device for each content stream. Equivalently, metadata indicating a respective presenting participant for each content stream may be transmitted to the viewing device. At 1406, a request to designate one of the presenting devices as a primary presenting device is received. The request may be received from that one device. For example, the conference participant associated with (e.g., using) that device may obtain the presenter role in the conference.

At 1408, an indication of the primary presenting device is transmitted to the viewing device. Transmitting the indication of the primary presenting device includes transmitting an indication that the conference participant is the presenter. The conferencing server continues to transmit all the content streams to the viewing device as long as the displays associated therewith at the presenting devices continue to be shared. The technique 1400 may transmit an indication of a focus display of the primary presenting device, if multiple displays of the primary presenting device are shared.

When the conferencing software designates one of the presenting devices as the presenting device, the conferencing software designates all of the other presenting devices as secondary presenting devices. When a primary presenting device is designated, the technique 1400 may transmit to a secondary presenting device (e.g., to each of the other presenting devices) a request to increase a compression rate with respect to content streams transmitted by the secondary presenting device.

A secondary presenting device may compress (e.g., encode) a content stream prior to transmitting that content stream to the conferencing server. Increasing the compression rate may involve encoding the content stream using more aggressive compression algorithms or settings, which can reduce the data size of the content stream before transmission to the server device. For example, the secondary presenting device may adjust the settings of its compression algorithm to a higher compression ratio, which reduces the bitrate and, consequently, the size of the content stream. A codec configuration that is more efficient in compressing screen content, possibly at the expense of some quality, may be selected. The secondary presenting device may lower the resolution or frame rate of the content stream, which would reduce the amount of data required to represent the stream.

The server device (e.g., the conferencing software therein) may itself increase compression ratios associated with received content streams from the secondary presenting devices. For example, the server device may receive a content steam from a secondary presenting device, may decompress (e.g., decode) the content stream, re-encode the content stream in such a way as to increase the compression ratio, and then transmit the re-compressed content stream to the viewing device.

The technique 1400 may determine whether to transmit at least some of the content streams to the viewing device based on input received from the viewing device. For example, and as described with respect to the stream selector area 906 of FIG. 9A, a viewing participant may select a subset of the shared displays. Based on the selection, the viewing device may transmit the list of selected displays (or content streams) to the server device. The server device may then stop transmitting the unselected content streams to the viewing device.

The technique 1400 may include recording one of the content streams at a first resolution and transmitting the one of the content streams at a second resolution that is lower than the first resolution. The conferencing software may receive an input (e.g., a command or a configuration) to record the conference. The conferencing software may also receive a recording template layout that configures how the conferencing software lays out the content streams in the recording. In an example, the recording template layout may indicate that the content streams are to be arranged in a grid.

The technique 1400 may increase compression rates associated with transmitting, to the viewing device, a content stream received from the secondary presenting device. The compression rate may be increased in response to the request to designate the one of the presenting devices as the primary presenting device. The technique 1400 may receive metadata from a presenting device that indicate the displays shared at the presenting device. The metadata may be a list of identifiers of the displays where the list of identifiers can be correlated with the content streams received from the presenting device. The metadata received from a presenting device can be associated with the presenting participant associated with that presenting device. The technique 1400 may aggregate all the metadata received from the presenting devices and transmits the aggregated metadata to viewing devices.

A request may be received to record the conference from a conference participant. An indication may be received that a content stream should not be transmitted to the device associated with the conference participant. For example, the conference participant may have not selected or unselected the content stream in the stream selector area 906 of FIG. 9. Nevertheless, the technique 1400 may still include the content stream in the recording. In an example, the technique 1400 may include only one of the content streams in a recording of the conference, where the only one of the content streams is associated with a focus display.

If the conference participant unselects a display associated with a content stream that is being transmitted to the viewing device of the conference participant, the technique 1400 stops transmitting the content stream to the viewing device, such as based on an indication received from the viewing device to stop transmitting the one of the content streams to the viewing device.

For simplicity of explanation, the techniques 1200, 1300, and 1400 of FIGS. 12, 13, and 14, respectively, are depicted and described herein as respective series of steps or operations. However, the steps or operations of the techniques 1200, 1300, and 1400 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The disclosure presented herein may be considered in view of the following.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. The method includes receiving, by a viewing device connected to a conference, a selection of a subset of content streams transmitted by presenting devices, where each of the content streams is transmitted from a respective presenting device connected to the conference, and where each presenting device is associated with a respective conference participant; receiving, by the viewing device, the subset of the content streams; and displaying, by the viewing device, at least one of the subset of the content streams. Other embodiments of this aspect include corresponding computer systems, apparatus, and computer programs recorded on one or more computer storage devices, each configured to perform the actions of the methods.

Implementations may include one or more of the following features. The method where displaying, by the viewing device, the at least one of the subset of the content streams may include receiving a selection of the at least one of the subset of the content streams; and in response to receiving the selection of the at least one of the subset of the content streams, displaying, by the viewing device, the at least one of the subset of the content streams. The at least one of the subset of the content streams may include at least two content streams, and where displaying, by the viewing device, the at least one of the subset of the content streams may include simultaneously displaying, by the viewing device, the at least two content streams.

The method may include receiving, by the viewing device, an indication to display another content stream of the subset of the content streams that is different from the at least one of the subset of the content streams; stopping, by the viewing device, the displaying of the at least one of the subset of the content streams; and displaying, by the viewing device, the another content stream.

The method may include receiving an indication that one of the content streams is a primary content stream; and in response to receiving the indication, highlighting, by the viewing device, the one of the content streams. Each of the at least one of the subset of the content streams can be associated with a tab of a tabbed user interface. The at least one of the subset of the content streams can be displayed in a grid user interface.

Implementations of the described techniques may include hardware, a method or process, or computer software on a computer-accessible medium.

One general aspect includes a viewing device connected to a conference. The viewing device includes a memory and a processor. The processor can be configured to execute instructions stored in the memory to receive a selection of a subset of content streams transmitted by presenting devices, where each of the content streams is transmitted from a respective presenting device connected to the conference, and where each presenting device is associated with a respective conference participant; receive the subset of the content streams; and display at least one of the subset of the content streams. Other embodiments of this aspect include corresponding computer systems, apparatus, and computer programs recorded on one or more computer storage devices, each configured to perform actions corresponding to the instructions.

Implementations may include one or more of the following features. The viewing device where the at least one of the subset of the contents streams can be displayed in response to a selection of the at least one of the subset of the content streams received from a user of the viewing device. The at least one of the subset of the content streams may include at least two content streams that are simultaneously displayed by the viewing device.

The processor can be configured to execute instructions stored in the memory to output an identifier of the respective conference participant in association with a corresponding one of the at least one of the subset of the content streams. The processor can be configured to execute instructions stored in the memory to receive an indication of a primary presenting device; and highlight one of the content streams corresponding to a focus display at the primary presenting device. The subset of the content streams may include a content stream associated with a secondary device connected to a presenting device. The processor can be configured to execute instructions stored in the memory to display the at least one of the subset of the content streams in a tabbed user interface.

Implementations of the described techniques may include hardware, a method or process, or computer software on a computer-accessible medium.

One general aspect includes a non-transitory computer readable medium storing instructions operable to cause one or more processors to perform operations. The operations include receiving, by a viewing device connected to a conference, a selection of a subset of content streams transmitted by presenting devices, where each of the content streams is transmitted from a respective presenting device connected to the conference, and where each presenting device is associated with a respective conference participant; receiving, by the viewing device, the subset of the content streams; and displaying, by the viewing device, at least one of the subset of the content streams. Other embodiments of this aspect include corresponding computer systems, apparatus, and computer programs recorded on one or more computer storage devices, each configured to perform the operations.

Implementations may include one or more of the following features. Displaying, by the viewing device, the at least one of the subset of the content streams may include displaying a respective identifier of a presenting participant in association with the at least one of the subset of the content streams. The at least one of the subset of the content streams can be displayed according to an arrangement received from a viewing participant associated with the viewing device. The operations may include receiving an indication that one of the presenting devices is a primary presenting device. The operations may include receiving an indication that one of the presenting devices is a secondary presenting device. The operations may include outputting, in a user interface, a list indicative of the content streams, where the selection of the subset of the content streams is received based on selections from the list. Implementations of the described techniques may include hardware, a method or process, or computer software on a computer-accessible medium.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a viewing device connected to a conference, a selection of a subset of content streams transmitted by presenting devices, wherein each of the content streams is transmitted from a respective presenting device connected to the conference, and wherein each presenting device is associated with a respective conference participant;
receiving, by the viewing device, the subset of the content streams; and
displaying, by the viewing device, at least one of the subset of the content streams.

2. The method of claim 1, wherein displaying, by the viewing device, the at least one of the subset of the content streams comprises:
receiving a selection of the at least one of the subset of the content streams; and
in response to receiving the selection of the at least one of the subset of the content streams, displaying, by the viewing device, the at least one of the subset of the content streams.

3. The method of claim 1, wherein the at least one of the subset of the content streams comprises at least two content streams, and wherein displaying, by the viewing device, the at least one of the subset of the content streams comprises:
simultaneously displaying, by the viewing device, the at least two content streams.

4. The method of claim 1, further comprising:
receiving, by the viewing device, an indication to display another content stream of the subset of the content streams that is different from the at least one of the subset of the content streams;
stopping, by the viewing device, the displaying of the at least one of the subset of the content streams; and
displaying, by the viewing device, the another content stream.

5. The method of claim 1, further comprising:
receiving an indication that one of the content streams is a primary content stream; and
in response to receiving the indication, highlighting, by the viewing device, the one of the content streams.

6. The method of claim 1, wherein each of the at least one of the subset of the content streams is associated with a tab of a tabbed user interface.

7. The method of claim 1, wherein the at least one of the subset of the content streams is displayed in a grid user interface.

8. A viewing device connected to a conference, comprising:
a memory; and
a processor, the processor configured to execute instructions stored in the memory to:
receive a selection of a subset of content streams transmitted by presenting devices, wherein each of the content streams is transmitted from a respective presenting device connected to the conference, and wherein each presenting device is associated with a respective conference participant;
receive the subset of the content streams; and
display at least one of the subset of the content streams.

9. The viewing device of claim 8, wherein the at least one of the subset of the contents streams is displayed in response to a selection of the at least one of the subset of the content streams received from a user of the viewing device.

10. The viewing device of claim 8, wherein the at least one of the subset of the content streams comprises at least two content streams that are simultaneously displayed by the viewing device.

11. The viewing device of claim 8, wherein the processor is configured to execute instructions stored in the memory to:
receive an indication of a primary presenting device; and
highlight one of the content streams corresponding to a focus display at the primary presenting device.

12. The viewing device of claim 8, wherein the subset of the content streams comprises a content stream associated with a secondary device connected to a presenting device.

13. The viewing device of claim 8, wherein the processor is configured to execute instructions stored in the memory to:
display the at least one of the subset of the content streams in a tabbed user interface.

14. The viewing device of claim 10, wherein the processor is configured to execute instructions stored in the memory to:
output an identifier of the respective conference participant in association with a corresponding one of the at least one of the subset of the content streams.

15. A non-transitory computer readable medium storing instructions operable to cause one or more processors to perform operations comprising:
receiving, by a viewing device connected to a conference, a selection of a subset of content streams transmitted by presenting devices, wherein each of the content streams is transmitted from a respective presenting device connected to the conference, and wherein each presenting device is associated with a respective conference participant;
receiving, by the viewing device, the subset of the content streams; and
displaying, by the viewing device, at least one of the subset of the content streams.

16. The non-transitory computer readable medium of claim 15, wherein displaying, by the viewing device, the at least one of the subset of the content streams comprises:
displaying a respective identifier of a presenting participant in association with the at least one of the subset of the content streams.

17. The non-transitory computer readable medium of claim 15, wherein the at least one of the subset of the content streams are displayed according to an arrangement received from a viewing participant associated with the viewing device.

18. The non-transitory computer readable medium of claim 15, wherein the operations further comprise:
receiving an indication that one of the presenting devices is a primary presenting device.

19. The non-transitory computer readable medium of claim 15, wherein the operations further comprise:
receiving an indication that one of the presenting devices is a secondary presenting device.

20. The non-transitory computer readable medium of claim 15, wherein the operations further comprise:
outputting, in a user interface, a list indicative of the content streams, wherein the selection of the subset of the content streams is received based on selections from the list.
